(19) United States
(12) Patent Application Publication
(10) Pub. No.: US 2014/0185928 A1
(43) Pub. Date: Jul. 3, 2014

(54) HARDWARE-SUPPORTED HUFFMAN CODING OF IMAGES

(71) Applicants: Shai Ben NUN, Kfar-Saba (IL); Lior LIBIS, Haifa (IL); Itay FRANKO, Herzlia (IL)

(72) Inventors: Shai Ben NUN, Kfar-Saba (IL); Lior LIBIS, Haifa (IL); Itay FRANKO, Herzlia (IL)

(21) Appl. No.: 13/729,764

(22) Filed: Dec. 28, 2012

(51) Int. Cl. G06T 9/00

(52) U.S. Cl. CPC G06T 9/005
USPC 382/166

(57) ABSTRACT

Embodiments of the present invention may provide a apparatus and method for compressing image data by dividing the data into color components data streams, taking the differences between successive pixels in the data streams, and coding these differences into a compressed data stream using a Huffman coding scheme. The compressed data may be transmitted to a decompressor over an interface. The decompressor may divide the compressed data stream back into color component data streams and decompress the pixels by adding the coded differences to reference values corresponding to previously decompressed pixels of the same color component to generate successive pixels of that color component. Merge registers may then recombined the decompressed data into the original image data. According to embodiments of the present invention, the compression/decompression process may be lossless.

### FIELD OF THE INVENTION

The present disclosure relates to rapid image compression through hardware-implemented, modified Huffman coding.

### DESCRIPTION OF RELATED ART

The extent of compression realized by application of conventional image compression techniques varies greatly depending on the image. Compression schemes, such as arithmetic coding, can take a very long time to compress. Moreover the schemes do not compress individual lines very efficiently or produce output that is segmented into lines.

Storage and processing of typical digital images require considerable amounts of memory, resulting in costly bandwidth and buffer allocation. In some systems, the image sensors are physically located too far from the processing chip to be connected through a standard interface, and a universal serial bus (USB) interface (in accordance with USB 3.0 Specification Revision 0.85, published Apr. 4, 2008) with limited bandwidth is used instead, creating a need for image compression. Additionally, image compression is necessary in order to transmit images over networks (eg. Local Area networks, Wide Area Networks, Wireless Local Area Networks, etc.) due to their limited bandwidths. Existing methods for the processing, compressing and storing of digital images are generally implemented via software algorithms, which often result in the loss of image quality and are costly in terms of execution time.

Thus, there is a need in the art for a method to efficiently and reliably compress image data at a small cost in execution time.

### DESCRIPTION OF THE FIGURES

Embodiments are illustrated by way of example and not limitation in the Figures of the accompanying drawings:

FIG. 1 is a block diagram of a computer system implementing data compression/decompression according to an embodiment of the present invention.

FIG. 2 is an illustration of a Bayer image pattern according to an embodiment of the present invention.

FIG. 3 is a graph of differences between pixels of a common color component of image data in a Bayer image pattern.

FIG. 4 is a block diagram of a compressor according to an embodiment of the present invention.

FIG. 5 is an indexed Bayer image pattern according to an embodiment of the present invention.

FIG. 6 is a Huffman code table according to an embodiment of the present invention.

FIG. 7 is an illustration of a compressed data stream according to an embodiment of the present invention.

FIG. 8 is a block diagram of a decompressor according to an embodiment of the present invention.

FIG. 9 is a block diagram of the architecture of a decompressor according to an embodiment of the present invention.

### DETAILED DESCRIPTION

The following description describes a non-computationally intensive and hardware-supported method and system for the reliable compression and decompression of image data.

In the following description, numerous specific details such as processing logic, processor types, micro-architectural conditions, events, enablement mechanisms, and the like are set forth in order to provide a more thorough understanding of embodiments of the present invention. It will be appreciated, however, by one skilled in the art that the invention may be practiced without such specific details. Additionally, some well known structures, circuits, and the like have not been shown in detail to avoid unnecessarily obscuring embodiments of the present invention.

Although the following embodiments are described with reference to a processor, other embodiments may be applicable to other types of integrated circuits and logic devices. Similar techniques and teachings of embodiments of the present invention may be applied to other types of circuits or semiconductor devices that can benefit from the efficient and reliable compression of digital images. The teachings of embodiments of the present invention may be applicable to any processor or machine that performs image data manipulations.

Embodiments of the present invention may provide an approach to reliably compressing image data for fast transfer between a sensor and a device to manipulate the image data. A system in accordance with an embodiment may encode images in two stages. In the first stage, a Bayer pattern image may be directly transferred from an image sensor to a compressor. A compressor module may divide the Bayer pattern into four data streams corresponding to the four color components of a Bayer image pattern: Green-Red [Gr]; Red[R]; Blue [B]; and Green-Blue [Gb]. At every clock cycle of the processing device, a quadrant of four pixels may be processed in this way, with each pixel of the quadrant corresponding to one color component of the Bayer image frame being processed. The image is processed via one four-pixel quadrant straddling two pixel lines at a every clock cycle.

The output pixels from the first stage may be input into four compression units corresponding, respectively, to the four color components of the Bayer image frame according to the availability of the compression units to process another pixel. When more than one compression unit is available at the same time, the pixels to be compressed may be distributed according to a predetermined tiebreaker order. These compression units may compress the image data by coding the difference between successive pixels of the same color into a hardware-implemented huffman code table. The compression device may also may transmit a signal of the start of compression and the length and width of the Bayer image frame being compressed to the decompressor module.

At the second stage, the huffman code may be unpacked by a decompressor. A decompressor module may extract the differences in the huffman code tables and send them to four decompression units corresponding to the four color components of the Bayer image frame as these differences become available. The four decompression units may decode the pixels and stream the decoded pixels to one of two merge registers, one corresponding to a [Gr] and [R] line and one corresponding to a [Gb] and [B] line. The merge registers may interleave and merge the received decoded pixels into lines. The lines may subsequently be combined back together and sent to video memory or other display buffers.

In an embodiment, at every clock cycle of the processing device, four pixels may be processed in this way, as they become available from the stream of coded pixels being unpacked.

In an embodiment, compressor and decompressor are generic terms to represent the source and destination of the corresponding image data. In some embodiments, they may be implemented within registers, memory, or other storage areas having other names or functions than those depicted.

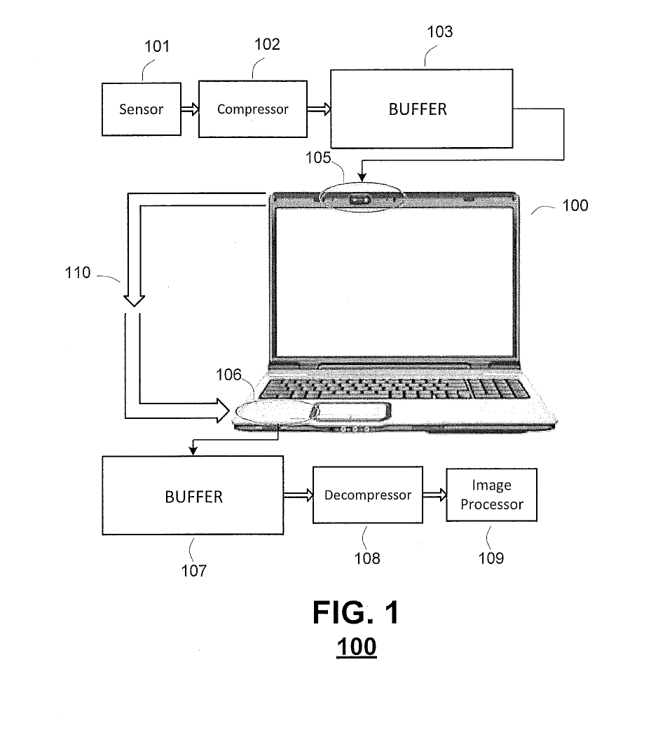

FIG. 1 is a block diagram of a computer system 100 according to an embodiment of the present invention. The computer system 100 may include an image capture device 105 and a central processor 106. Image capture device 105 may include image sensor 101 which may communicate with a compressor 102 and a buffer 103. Central processor 106 may be associated with a buffer 107 and may include execution units capable of data compression (listed as decompressor 108 for simplicity) and image processing (listed as image processor 109 for simplicity).

During operation, image capture device 105 may capture image data using sensor 101. The captured image data may then be compressed by compressor 102 (described in further detail below) and the compressed data may be stored at buffer 103. The compressed data may be transmitted, via interface 110, to buffer 107 and decompressed by decompressor 108 (described in further detail below). The decompressed data (which is the same as the originally captured image data) is then processed by processor 106.

Embodiments of the present invention are not limited to computer systems. Alternative embodiments of the present invention can be used in other devices that may manipulate images, such as handheld devices. Some examples of handheld devices include, inter alia, cellular phones, Internet Protocol devices, digital cameras, personal digital assistants (PDAs), and handheld personal computers (PCs). Moreover, embodiments of the present invention are not limited to transmitting compressed data over a computer interface. Alternative embodiments may transfer compressed image data over networks (e.g. LAN, WLAN, WAN, etc.) to Decompressors in other devices.

Image Compression

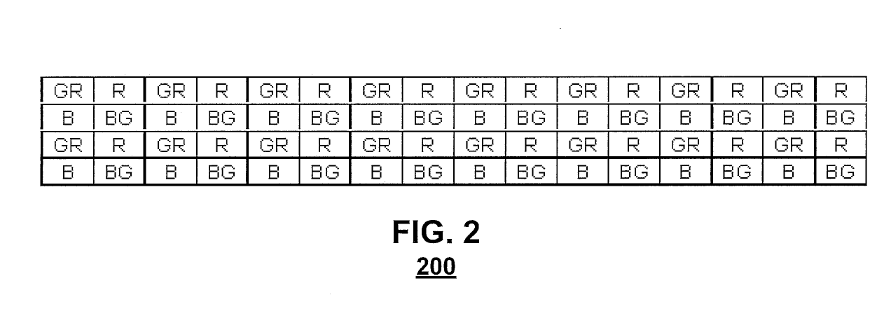

FIG. 2 Illustrates a segment of uncompressed image data read by an image sensor (Color Filter Array) in the form of a Bayer image frame 200.

It is assumed for the purposes of one illustrative embodiment that the top horizontal line of pixels in the Bayer pattern may contain alternating [Gr] and [R] pixels, and that the second horizontal pixel line contains alternating [B] and [Gb] pixels. The illustrative embodiment describes an uncompressed Bayer image data frame 200 in this order as an example, however, embodiments of the present invention may apply to any pattern of alternating color components arranged in a Bayer image frame.

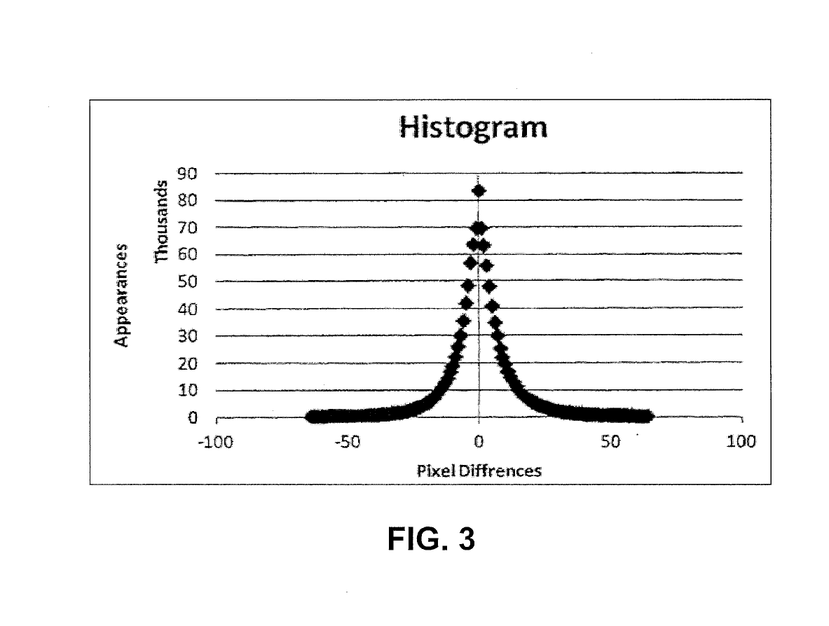

In one embodiment, the compression scheme may assume that there is a high probability of a strong correlation between successive pixels of the same color in a given Bayer image frame. FIG. 3 is a histogram of the numerical difference between successive pixels of the same color (Pixel (n)−Pixel (n−1)) in the Bayer frame of most images. The histogram shows the diversity of a majority of successive pixels of the same color to be near zero. The compression of the image data according to an embodiment may therefore be based on storing only the difference between two successive pixels of the same color, and coding that difference using a Huffman code. By ascribing short words to the differences that are close to zero within the Huffman code, a high compression ratio (approx. 50%) may be achieved. The coded image data may then be stored in a hardware-implemented Huffman table for maximum processing efficiency (described in further detail below).

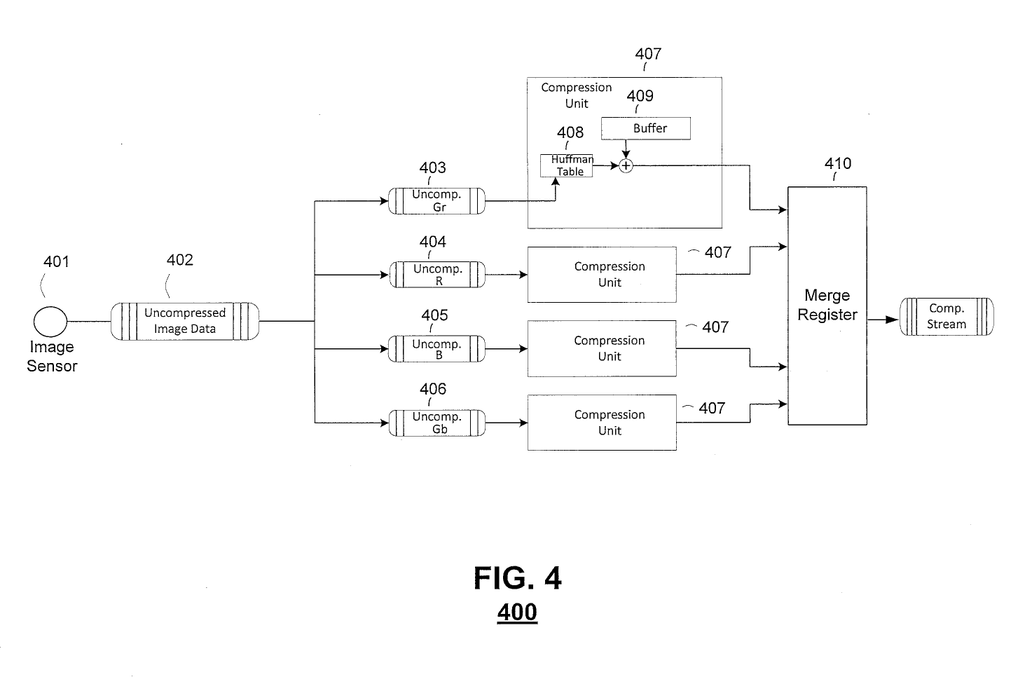

FIG. 4 is a block diagram of a compressor 400 according to an embodiment of the present invention, compressor 400 may include compression units 407 and a merge register 410.

The compression of uncompressed image data 402 (generated by an image sensor 401) in the form of a Bayer image frame (similar to the Bayer image frame 200 of FIG. 2) may be done by color component. Consequently, the four compression units 407 may correspond, respectively, to each of the four color components in the Bayer pattern being compressed: [Gr], [R], [Gb], [B]. During operation, a compressor module (not shown) divides the uncompressed image data 402 into four color component data streams 403-406 which correspond to the color components in the Bayer pattern.

Each corresponding compression unit may compress and code the pixels within associated data streams using a hardware implemented Huffman coding scheme 408 (described in more detail below) and output the coded pixels to merge register 410. The merge register 410 may interleave packs of coded pixels into a stream of compressed data to be transmitted to a decompressor (not shown but described in further detail below). The compressed data may be transmitted to the decompressor over various interfaces, such as a USB interface or a network interface.

In an embodiment, a quadrant of four pixels comprising one pixel for each color component (two from one horizontal line and the two from the horizontal line below) may be processed at every clock cycle. Thus, four pixels may be compressed per clock cycle.

Compression Algorithm

At the start of compression, the initial four pixel values from the initial quadrant to be processed may be streamed in the following order: [Gr][R][B][Gb]. The first pixel of each color component may be transferred to its corresponding compression unit 407 as received from the sensor 401 (i.e., uncompressed) and used as the original reference value against which the successive pixels of the same color on the same line of the Bayer image frame are coded.

For successive pixels of a given color component ([Gr], [R], [B], or [Gb]), the compression of each pixel of the same color component may achieved by calculating the numerical difference between that new pixel and the currently stored reference value for that color. That difference may be coded into a Huffman code. The Huffman coded values may be stored in a hardware-implemented Huffman code table 408 in a dedicated buffer 409. In other words, for the second pixel of a certain color to be coded, the difference between that second pixel and the initial pixel of the same color may be coded into the Huffman code table 408. The reference value may be updated by adding the value of the last coded difference to the previous reference value.

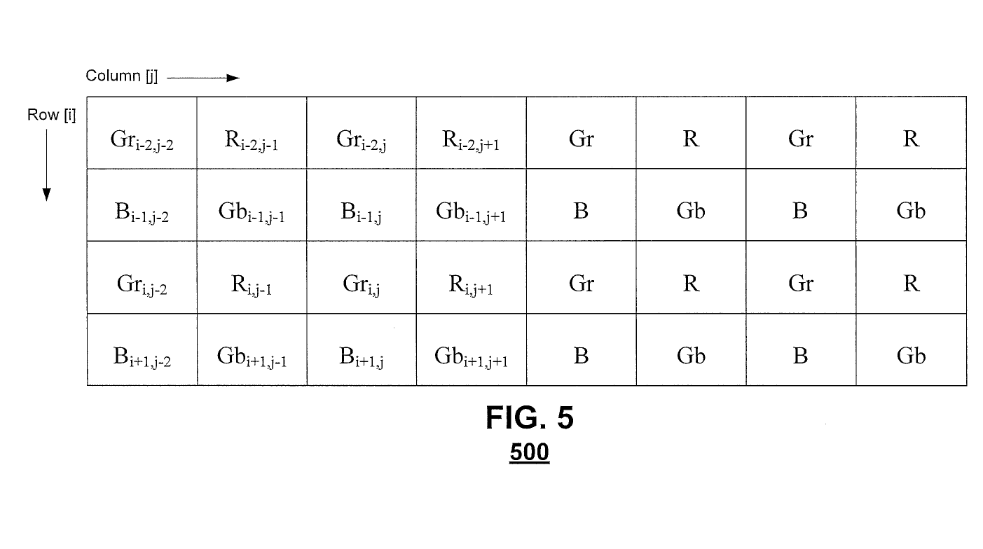

FIG. 5 illustrates an indexed segment of uncompressed image data read by an image sensor in the form of a Bayer image frame 500 according to an embodiment of the present invention. The coordinates [i,j] represent the locations (by [row,column]) of a given pixel in the Bayer image frame 500. The difference value of a given pixel (representing the value to be coded) in the Bayer image, located at coordinates [i,j] in the initial Bayer image frame array, may be determined using the following equations:

DiffVal(Gr_{i,j})=Gr_{i,j}−Gr_{i,j-2} Eq. 1

DiffVal(R_{i,j})=−R_{i,j}−2 Eq. 2

DiffVal(B_{i,j})=B_{i,j}−B_{i,j-2} Eq. 3

DiffVal(Gb_{i,j})=Gb_{i,j}−Gb_{i,j-2} Eq. 4

For example, the difference value of the red pixel at row 1, column 4 (where i=1 and j=4) may be derived by the following equation:

Pred(R_{1,4})=R_{1,4}−R_{1,2} Eq. 5

The calculated pixel difference values may be smaller than the original pixel values (or Reference Values), and thus may be represented by fewer bits. In addition, the differences may be coded using a Huffman code, which allocates fewer bits for coding the values that appear more frequently. The Huffman table may be hardware-implemented and thus highly efficient.

In an embodiment, the pixels of the quadrant being processed may be sorted and sent to a compression unit of the corresponding color. Moreover, the distribution may be done without handshaking between the sensor's buffer and the compressor or between the compressor and decompressor.

In an embodiment, the pixels may be sent to the compression units according to their availability. In the event that two or more compression units become available at the same time or within a preset threshold delay, the pixels are sent to the compression units according to the initial priority order applied to the first four pixels to be processed. In one embodiment, that order may be [Gr][R][B][Gb]. Thus, compression units may continuously feed pixels of the appropriate color until the entire frame being compressed has been processed.

In a preferred embodiment, a register table may hold the differences that were coded during the compression phase. Each table may include several registers of the same length.

Huffman Coding Scheme

In an embodiment, the Huffman coding and Huffman table may be implemented via hardware.

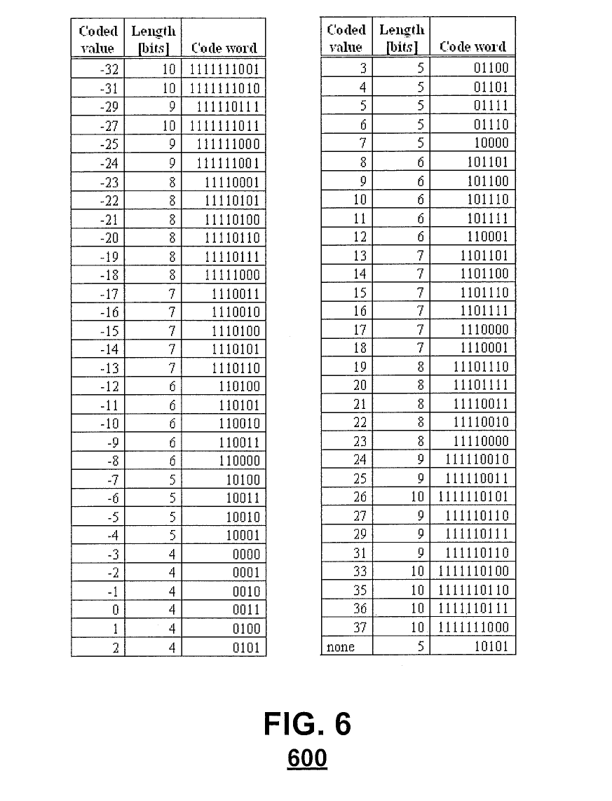

FIG. 6 is an example of a Huffman table 600 according to an embodiment of the present invention. The table lists coded difference values between successive pixels of the same color and corresponding code words and their lengths (in bits). For example, if the difference between two successive pixels of the same color is three, the code word is “01100.” The length of the coded words may increase as the coded (absolute) difference values increase. The values of successive pixel of the same color typically do not vary significantly, therefore the coded difference values may be smaller than the original pixel values. The pixels may be represented by fewer bits in this manner. Moreover, because the differences between successive pixels of the same color are typically small, Huffman coding may further increase the compression ratio of the system.

According to an embodiment of the present invention, the compressor and decompressor may support a loadable Huffman table with up to 128 entries. For images of 10 bits per pixel, a good compression ratio may be achieved with a 64 entry Huffman table.

Compressed Stream Format

In an embodiment, after Huffman coding of the pixel value differences according the method described above, the code words for the differences for each of the four color components may be gathered and packed into separate streams of 64-bits words. The 64-bit words are then interleaved to create a single stream.

The compression ratio and packing speed may be different between the color components. Consequently, the pixels may be distributed to appropriate compression units in a deterministic fashion, based on which compression unit is available for processing as a pixel becomes available to be processed. Thus, there may not be a fixed interleaving scheme.

According to an embodiment, the first four packets of the compressed stream may be in the following order: [Gr][R][B][Gb]. The next packet to be placed in the stream may be determined based on the number of uncompressed bits left from the previous packet of each color.

According to an embodiment, the longest uncompressed sample length may be defined by the length of the code word indicating that the value is uncompressed (according to the Huffman table definition), and the length of the sample (according to the sensor bit depth). During decompression, if a color component packet has less than this number of bits in the uncompressed packet, the next 64-bits packet may be from that color. If more than one decompression unit is in such a state, the conflict may be resolved according to the original tiebreaker order.

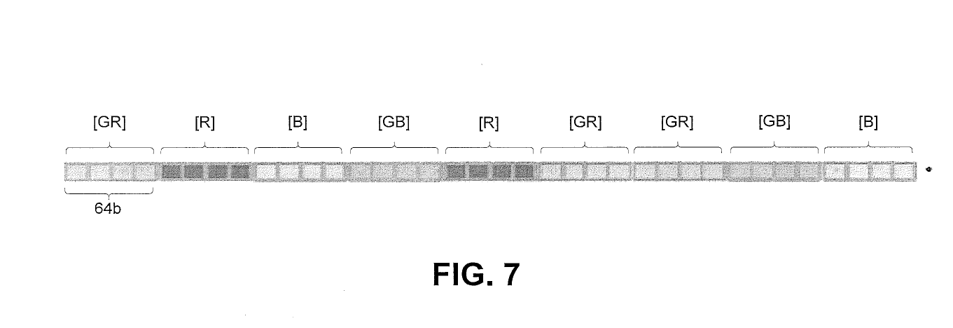

FIG. 7 illustrates a compressed stream of pixel data according to an embodiment of the present invention. The stream may contain successive 64-bit words representing the difference values for the color components. As described above, there may not be a fixed interleaving scheme. Each time a packet of color X is about to be filled, a new packet may be presented. For example, in FIG. 7, the compressed stream of pixel data may have the following interleaving scheme: [GR], [R], [B], [GB], [R], [GR], [GR], [GB], [B], etc. The scheme may, however, vary during operation.

Communication with Decompressor

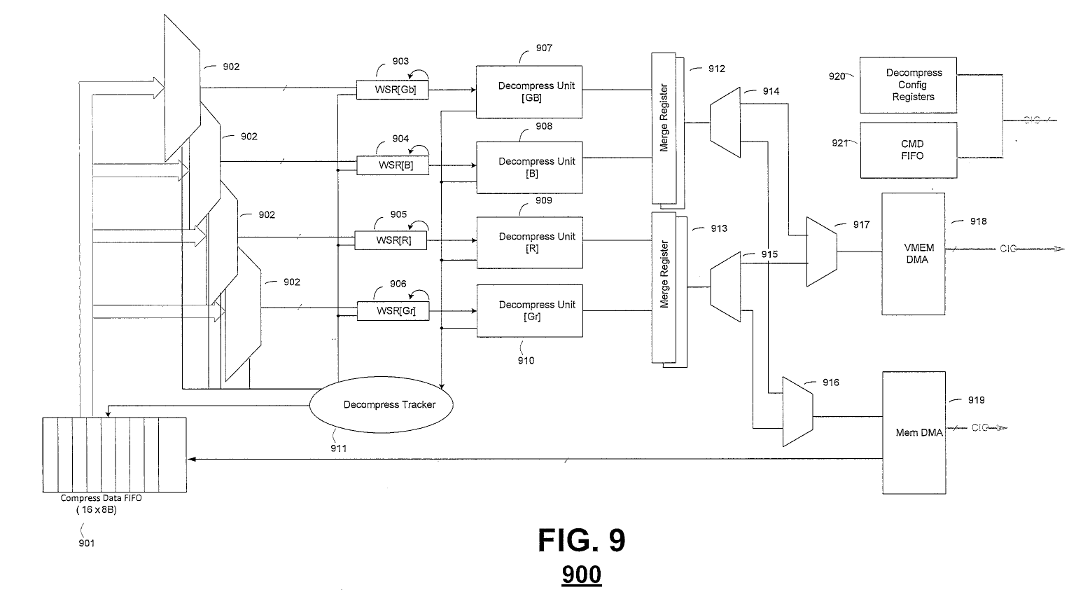

According to an embodiment, at the initiation of compression of a new image frame, the compressor may communicate a “Start New Frame” signal and the width and length of the Bayer image frame to be compressed to the decompressor. The decompressor may store this information in appropriate registers (see Register 902 of FIG. 9). This information may be used by the decompressor to track the number of pixels that have been decompressed and to determine if the frame at issue has been fully decompressed. It may be assumed that compression and decompression of a pixel of a given color are completed in the same time.

Decompression

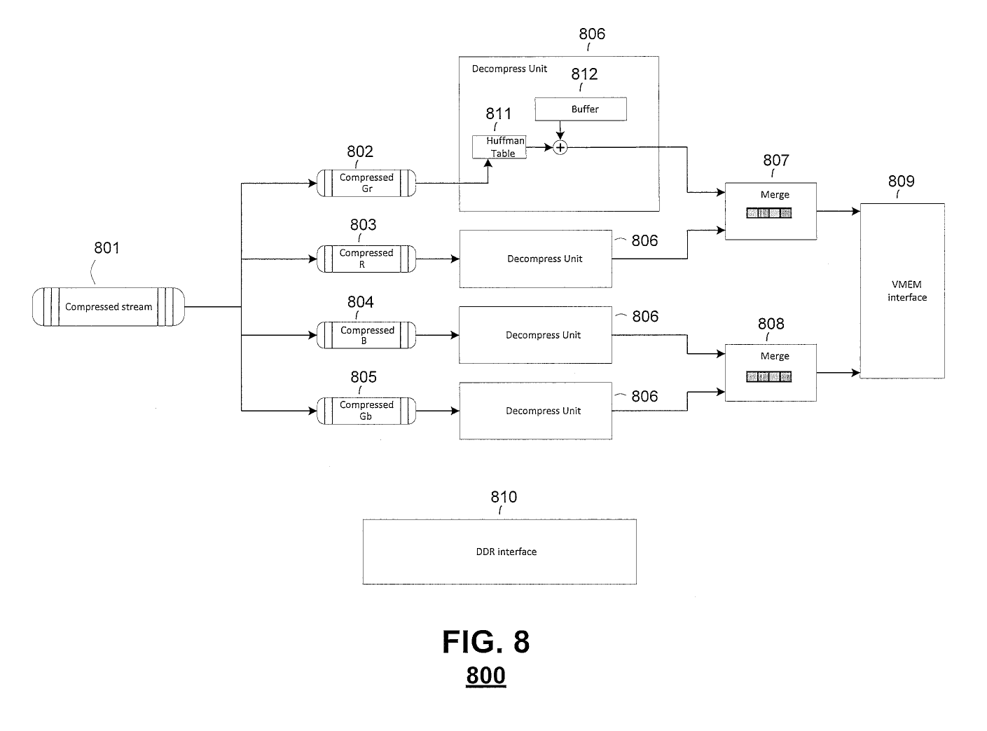

FIG. 8 is a block diagram that illustrates the decompression process performed by a decompressor 800, decompressor 800 may include an external double data rate memory (DDR) interface 810 to provides access to a stream of compressed data 801, decompression units 806 to decompress streams of compressed pixel data, merge registers 807, 808 to merge pixel data decompressed by decompression units 806, and a vector memory (VMEM) interface 809 to write decompressed pixel vectors to the VMEM. The decompressor 800 may also write decompressed pixel data to the DDR using DDR interface 810.

Each decompression unit 806 contains a corresponding Huffman table 811 to decode the coded pixel data and a buffer 812 to temporarily store the decoded pixel data prior to transmitting the data from the decompression units 806 to corresponding merge registers 807, 808.

During operation, a stream of compressed data 801 may be accessed from the DDR interface 810 and split into four compressed color component data streams (802-805) corresponding to each color component of the Bayer image frame using a decompressor module (not shown). The four streams 802-805 may be sent to the appropriate decompression units 806 for decompression (described in further detail below) according to the order that they were compressed in by a compressor. The decompressed pixels may be merged by two merge registers 807, 808. The two pixel lines produced by the merge registers 807, 808 may be combined and sent to VMEM interface 809.

According to an embodiment, decompressor 800 may perform the decompression of four pixels per clock cycle.

Decompressor Structure

FIG. 9 is a block diagram illustrating the architecture of a decompressor 900 according to an embodiment of the present invention. Decompressor 900 may include a compressed data first-in-first-out (FIFO) 901, four work-shift registers (WSR) 903-906 and corresponding decompress units 907-910 for each color component of a Bayer image frame, a decompress tracker (DT) 911, merge megisters 912, 913, a VMEM (vector memory) direct memory access (DMA), an external memory (DDR) DMA, a command (CMD) FIFO, and decompressor configuration registers 920 (which may be used to configure the decompressor 900 for operation), decompressor 900 may also include multiplexers 902 to facilitate the transfer of compressed pixel data from compress data FIFO 901 to corresponding WSRs 903-906 and multiplexers 914-916 to facilitate the transfer of decompressed pixel data from Merger Registers 912, 913 to VMEM DMA 918 and DDR DMA 919.

The four WSRs 903-906 may store compressed data for each decompressor unit 907-910 to work on, one for each color component of the Bayer image. At each clock cycle, the WSRs 903-906 send data to the decompression units 907-910 and shift a corresponding number of bits.

DT 911 may monitor the number of decoded pixels being written to merge register 912, 913 and signal the DMAs 918, 919 to write when a merge register 912, 913 is ready.

WSRs 903-906 may be 86 bits wide (each compressed packet is 64b+22b and is the longest compress stream that may hold 1 pixel). Each WSR 903-906 may receive compressed data from the compress data FIFO 901 and send it to a corresponding decompress unit 907-910. Each decompress unit 907-910 may take the least significant bits (LSBs) of a corresponding WSR 903-906 and find the difference that they encode. The decompress units 907-910 may then shift corresponding WSRs 903-906 accordingly. The number of bits that can be used for the decode may vary between 4 to 22.

Decompress Tracker

In an embodiment, the Decompress Tracker (“DT”) 911 may control the compress and decompress flow of the system. The DT 911 may monitor the command FIFO 921 and start a DMA 919 read cycle once the command FIFO's 921 head points to a new command to be executed. The DT 911 may send an acknowledgement once the command has been completed.

The DT 911 may further monitor the WSRs 903-906 and refill them as needed. The DT 911 may monitor the number of compressed bits inside WSRs 903-906. The DT 911 may upload 64b to each WSR 903-906. At each clock cycle, the DT 911 may monitor decompress units 907-910 to determine the number of bits in the corresponding WSRs 903-906 that were used for the latest decompression. DT 911 may subtract this number from the current number of bits left the corresponding WSRs 903-906. Once the number of bits in a specific register reaches a 22 bit threshold, the DT 911 may reload it with one more 64 bit packet. If two WSRs 903-906 reach the threshold in the same cycle (resulting in a tie), then DT 911 may reload them according to the initial order of compression (e.g.,[Gr][R][B][Gb]).

In cases where the compress data FIFO 901 is empty during a command execution and (at least) one of the WSRs 903-906 needs more data, DT 911 may halt the WSRs 903-906 until the compress data FIFO 901 is refilled.

DT 911 may also be responsible for managing and writing to the merge registers 912, 913. During every cycle, two pixels may be written to each merge register 912, 913—[Gr],[R] to one register 913 and [B],[Gb] to the other register 912—for a total of four pixels processed per clock cycle. The merge registers 912, 913 may include a different number of pixels depending the transmission rate (8, 10, or 12 bits per second) and the target (DDR or VMEM). Thus, DT 911 may be responsible for writing to the right location and informing the DMAs 918, 919 once a given merge register 912, 913 is full.

Decompression Units

According to an embodiment, the four decompression units 907-910 may take the least significant bit (LSB) of the WSRs 903-906 and extract the coded differences from the Huffman code. Subsequently, the four decompress units 907-910 may add the decoded difference to the last pixel's value and send the decompressed pixels to one of two merge registers 912, 913 (while also saving the value of the last decompressed pixel as a reference value to perform the next pixel's decompression). In addition, the decompress units 907-910 may send the length of the code word being processed to the WSRs 903-906 so they may shift properly.

The decompressed pixels may then be written and interleaved to the merge registers 912, 913. DT 911 may monitor this process and when a merge register 912, 913 is full, the DT 911 may send an indication to the relevant DMA 918, 919 to send the data in the full merge register 912, 913 to the relevant target (VMEM or DDR). As discussed above, embodiments of the present invention may include two merge registers 912, 913, each corresponding to a pair of colors from the four basic color components of the Bayer image (see FIG. 2). Once one of the merge registers (e.g., 912) is full, the DT 911 may start to fill the second merge register (913).

DMAs

According to an embodiment, the decompressor 900 may include two DMAs, one for DDR accesses 919 and one for VMEM accesses 918.

Decompressed data may be outputted to the DDR or to the VMEM. The DDR DMA 919 may send the read and write requests towards the DDR (not shown). The VMEM DMA 918 may send the write requests towards the VMEM (not shown)

Embodiments of the improved Huffman code image compression and decompression disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof The instruction converter may be on processor, off processor, or part on and part off processor.

Thus, techniques for implementing an improved Huffman code compression of images according to at least one embodiment are disclosed. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A device comprising:
a compressor module to receive image frame data comprising a plurality of pixels with different color components and split the frame into color component data streams, one for each color component; and
a plurality of compression units, one for each color component data stream, to compress pixels in each color component data stream by taking a difference between successive pixels having the same color component and coding the differences; and
a merge register to interleave packs of coded differences into a stream of compressed data.

2. The device of claim 1, wherein the coding comprises a hardware-implemented Huffman coding scheme.

3. The device of claim 1, wherein the compressed data is transmitted to a decompressor over an interface.

4. The device of claim 3, wherein the interface is a USB interface.

5. The device of claim 3, wherein the interface is a network interface.

6. The device of claim 3, wherein the decompressor is to:
divide the compressed data stream back into color component data streams corresponding to each of the color components; and
decompress the pixels in each color component data stream by adding the coded differences to reference values representing previously decompressed pixels of the same color component to generate successive pixels of that color component.

7. The device of claim 6, further comprising
merge registers to recombine the decompressed color component data streams into the original image frame data; and
a memory to store the original image frame data.

8. The device of claim 1, wherein the compression is lossless.

9. The device of claim 1, wherein the image frame data is in a Bayer pattern comprising four color components.

10. A method comprising:
compressing an image frame that comprises pixels with different color components by:
splitting the image frame into a plurality of color component data streams, one for each color component;
taking a difference between successive pixels having the same color component in each of the color component data streams; and
coding these differences into a compressed data stream comprising compressed sets of pixels having the same color component; and
transmitting, over an interface, the compressed data stream to be decompressed.

11. The method of claim 10, wherein the coding comprises a Huffman coding scheme.

12. The method of claim 10, wherein the interface is a USB interface.

13. The method of claim 10, wherein the interface is a network interface.

14. The method of claim 10, wherein the image frame data is in a Bayer pattern comprising four color components.

15. The method of claim 10, further comprising:
decompressing the compressed data stream by:
dividing the compressed data stream back into color component data streams corresponding to each of the color components; and
for each color component data stream, adding the coded differences to reference values representing previously decompressed pixels of the same color component to generate successive pixels of that color component;
recombining the decompressed color component data streams into the original image frame; and
storing the original image frame in memory.

16. The method of claim 10, wherein the compression is lossless.

17. A system comprising:
an image sensor to capture image data and generate image frame data comprising pixels with different color components;
a compressor to:
divide the image frame into a plurality of color component data streams, one for each color component;
compress each of the color component data streams by taking a difference between successive pixels having the same color component and coding the differences;
generate a compressed data stream comprising compressed sets of pixels having the same color component;
a decompressor to:
receive the compressed data stream over an interface
divide the compressed data stream back into color component data streams corresponding to each of the color components; and
decompress each of the color component data streams by adding the coded differences to reference values representing previously decompressed pixels of the same color component to generate successive pixels of that color component;
merge registers to recombine the decompressed color component data streams into the original image frame data; and
a memory to store the original image frame data.

18. The system of claim 17, wherein the coding comprises a hardware-implemented Huffman coding scheme.

19. The system of claim 17, wherein the interface is a USB interface.

20. The system of claim 17, wherein the interface is a network interface.

21. The system of claim 17, wherein the image frame data is in a Bayer pattern comprising four color components.

22. The system of claim 17, wherein the compression is lossless.
